(19) United States
(12) Patent Application Publication
(10) Pub. No.: US 2023/0212036 A1
(43) Pub. Date: Jul. 6, 2023

(54) FLOTATION CELL FOR WATER TREATMENT

(71) Applicant: YPF TECNOLOGÍA S.A., Ciudad Autónoma de Buenos Aires (AR)

(72) Inventors: Vanesa Melina PAREDES MUÑOZ, Berisso (AR); Nery CANO, Buenos Aires (AR)

(21) Appl. No.: 18/150,915

(22) Filed: Jan. 6, 2023

Related U.S. Application Data
(60) Provisional application No. 63/297,023, filed on Jan. 6, 2022.

(51) Int. Cl. C02F 1/24; C02F 1/00; B01D 21/00; B01D 21/32

(52) U.S. Cl. CPC C02F 1/24; C02F 1/008; B01D 21/0084; B01D 21/32; C02F 2209/02

(57) ABSTRACT

A flotation cell for water treatment comprising: a hollow cylindrical body comprising an upper opening, a lower opening and a plurality of conduits distributed on an outer surface of the cylindrical body; an upper lid and a lower lid attached to the cylindrical body to cover the upper opening and the lower opening, respectively, of the cylindrical body, wherein each lid comprises a conduit; a band heater located on the outer surface of the cylindrical body, surrounding the cylindrical body; a support structure comprising a plurality of bars for supporting the cylindrical body and the upper and lower lids; and a control unit attached to the support structure.

### FIELD OF THE INVENTION

The present invention relates to the technical field of devices for water treatment. More particularly, the present invention relates to a flotation cell for water treatment by gas injection on a laboratory scale.

### BACKGROUND OF THE INVENTION

Field water treatment equipment such as Wemco flotation cells are well known in the state of the art. To optimize the performance of these flotation cells it is important to carry out laboratory scale studies in order to know the effect of different parameters on the water treatment.

A well-known device in the state of the art is the IFPEN flotation cell, which is used to study the impact of different parameters in water treatment requested by different customers in the industry but, since it is an open cell, it does not allow studies to be carried out when foam is generated. This is because, depending on whether the system components have natural or added surfactants, when air enters, the formation of foams and their ascent through the column can be very fast having to suspend, or directly discard in its totality, the tests. This is due to the fact that part of the fluids, which are being studied, are lost through the overflow that occurs at the top of this flotation cell, since it does not have a lid and does not allow controlling the level of foam that is generated.

It should be noted that the formation of foam is difficult to control if there is sufficient surfactant and a certain pressure difference to favor gas migration out of the liquid.

Consequently, there is a need to provide a device that allows to study the different parameters that affect water treatment independently of the generation or not of foam during a test.

### BRIEF DESCRIPTION OF THE INVENTION

Based on the above considerations, the present invention provides a flotation cell that allows studying the effect of different parameters in water treatment and that tolerates the generation of foam in the cell without affecting the performance of different tests.

Accordingly, it is an object of the present invention a flotation cell for water treatment comprising:
a hollow cylindrical body or vessel comprising an upper opening, a lower opening and a plurality of conduits distributed on an outer surface of the cylindrical body;
an upper lid and a lower lid attached to the cylindrical body to cover the upper opening and the lower opening, respectively, of the cylindrical body, wherein each lid comprises a conduit;
a band heater located on the outer surface of the cylindrical body, surrounding the cylindrical body;
a support structure comprising a plurality of bars for supporting the cylindrical body and the upper and lower lids; and
a control unit attached to the support structure.

In an embodiment of the present invention, the plurality of conduits of the body is located above a middle part of the body.

In an embodiment of the present invention, the plurality of conduits of the body comprises four conduits located at a same height of the cylindrical body and spaced 90° apart from each other in relation to a central longitudinal axis of the cylindrical body.

In a preferred embodiment of the present invention, the plurality of conduits of the body comprises eight conduits, wherein four conduits of the eight conduits are located at a first height of the cylindrical body, spaced 90° apart from each other in relation to the central longitudinal axis of the cylindrical body; and wherein the remaining four conduits of the eight conduits are located at a second height of the cylindrical body, above the first height, spaced 90° apart from each other in relation to the central longitudinal axis of the cylindrical body.

In an embodiment of the present invention, the body comprises an additional conduit for placing measuring instruments, preferably, the additional conduit comprises an elongated body for placing a temperature sensor.

In an embodiment of the present invention, a temperature sensor adapter is placed in at least one of the conduits of the cylindrical body.

In an embodiment of the present invention, the cylindrical body comprises, in a lower part thereof, interchangeable porous plates that are supported by the lower lid.

In an embodiment of the present invention, the band heater is located below the middle part of the cylindrical body.

In an embodiment of the present invention, the control unit is a control panel.

### BRIEF DESCRIPTION OF THE FIGURES

FIG. 1 shows a front view of the flotation cell of the present invention.

FIG. 2 shows a right side view of the flotation cell of FIG. 1.

FIG. 3 shows a top view of the flotation cell of FIG. 1.

FIG. 4A shows an isometric perspective view of the body of the flotation cell with an exploded conduit.

FIG. 4B shows a detail view of the conduit.

FIG. 5 shows a top view of the body of the flotation cell of the present invention.

FIG. 6 shows a front view of the body of the flotation cell of the present invention.

FIG. 7A shows an exploded perspective view of the flotation cell of the present invention.

FIG. 7B shows a detail view of the upper lid of the flotation cell of FIG. 7A.

### DETAILED DESCRIPTION OF THE INVENTION

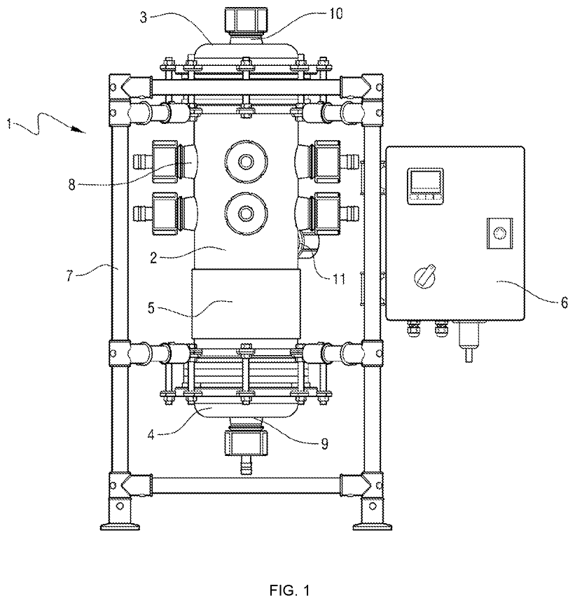

The flotation cell of the present invention will be described in detail below with reference to FIGS. 1 to 7B which illustrate, by way of example, an embodiment of the invention and the various elements thereof.

In each of the figures the same reference numbers are used to refer to similar or the same elements of the device of the present invention.

Referring to FIG. 1 a front view of the flotation cell 1 can be seen, the flotation cell 1 comprising a cylindrical body 2, an upper lid 3, a lower lid 4, a band heater 5, a control unit 6 and a support structure 7.

The cylindrical body 2 is hollow and comprises upper and lower openings at its vertically opposite ends which are covered, respectively, by the upper lid 3 and the lower lid 4. Additionally, the cylindrical body 2 comprises a plurality of conduits 8 projecting from, and arranged on, the outer surface of the cylindrical body 2. These conduits 8 are located above a middle part of said body 2.

In particular, for the embodiment shown in FIG. 1, the plurality of conduits 8 comprises eight conduits, wherein four conduits 8 of the eight conduits 8 are located at a first height of the cylindrical body 2, spaced 90° apart from each other in relation to a central longitudinal axis of the cylindrical body 2; and wherein the remaining four conduits 8 of the eight conduits 8 are located at a second height of the cylindrical body 2, above the first height, spaced 90° apart from each other in relation to the central longitudinal axis of the cylindrical body 2. Thus, there are four lower conduits 8 located at the first height and four upper conduits 8 located at the second height.

In this embodiment, since the conduits 8 are located at two different heights, the flotation cell 1 of the present invention allows working with two working test volumes, for example, with 4 liters and 5 liters, wherein one or the other volume is operated depending on the total amount of sample to be tested available. The function of said conduits 8 is to evacuate the supernatant obtained from the cleaning by gas bubble-carrying. In addition, the conduits 8 can be connected to hoses to collect the fluid for analysis. Thus, depending on the test, the conduits 8 can be used to dose products (e.g. flocculants, coagulants, clarifying agents, demulsifiers, etc.) or to take samples from another level.

It should be noted that, although eight conduits 8 are shown, the cylindrical body 2 may comprise a different number of conduits 8 as required. For example, the cylindrical body 2 may comprise only four conduits 8 located at the same height of the cylindrical body 2 and spaced 90° apart in relation to the central longitudinal axis of the cylindrical body 2. In the latter case, only one of the two working volumes would be used.

The cylindrical body 2 comprises, preferably, a total inner volume of 7 liters of which 4 or 5 liters are used with liquid fluid and the remaining volume is used as a containment chamber for gas and possible formation of foams (depending on the fluids to be tested).

When the flotation cell 1 is operating at the minimum test volume, for example, the volume of 4 liters, the upper conduits 8 are closed so as to allow more height of the column which allows a foam thickness controlled by pressure regulation through the upper lid 3.

On the other hand, if operating at the maximum volume of, for example, 5 liters, one of the four lower conduits 8 can be used to take samples, for example, from the conduit closest to the supernatant. In addition, in at least one of said conduits 8 a temperature sensor adapter can be placed so as to sample at points close to the gas injection.

As is evident said inner volume is easily modifiable by scaling the dimensions of the flotation cell of the present invention. Thus, in case it is required to work with large or small volumes, the dimensions of the flotation cell and, consequently, of the cylindrical body, will be larger or smaller, respectively. Moreover, the position of the conduits 8 on the outer surface of the cylindrical body 2 could be modified. Thus, taking into consideration either of these two characteristics, the working volumes would be different from, for example, 4 liters and 5 liters.

As described above, the body 2 comprises upper and lower openings which are covered, respectively, by the upper lid 3 and lower lid 4, wherein the upper lid 3 comprises a conduit 10 and the lower lid 4 comprises a conduit 9.

The conduit 9 is used to inject gas (during the test) and, depending on the suspended solids content of the sample to be tested, fluids can be evacuated through this conduit.

The conduit 10 is used to load the sample to be tested (before the test) and to regulate the pressure (during the test), if necessary, in order to control a possible generation of foams inside the body 2. More precisely, the conduit 10 allows the entry of the water to be studied into the body 2, wherein said water to be studied will comprise hydrocarbons and suspended solids as is evident to an expert in the corresponding technical field.

The cylindrical body 2 is made of transparent material, preferably borosilicate glass 3.3. The cylindrical body 2 allows operation up to 200° C. and withstands slight overpressures up to 10 psi.

The control unit 6 is a control or command panel by means of which temperature regulation is enabled within the cylindrical body 2. More precisely, the panel serves to regulate temperature by means of the band heater 5.

The support structure 7 supports above the ground the cylindrical body 2 in a vertical position together with the upper lid 3 and the lower lid 4. For this purpose, the support structure 7 comprises a plurality of vertical and horizontal bars, wherein the control unit 6 is attached to one of the vertical bars, as seen in FIG. 1, so that it is also supported by the support structure 7.

The flotation cell 1 of the present invention allows studying the effect of most of the parameters influencing water treatment by gas injection. These influencing parameters are bubble size distribution, gas flow rate, gas composition, temperature, salinity, pH and concentration of suspended solids of different nature.

The flotation cell 1 of the present invention allows gas to be injected or bubbled into the body 2 to facilitate the flotation of hydrocarbons and suspended solids. As described above, the gas is injected through conduit 9 of the lower lid 4, which supports interchangeable porous plates (not shown) of different pore size distribution and/or material according to the desired bubble size to be dispersed in the fluid under study.

The flotation cell of the present invention has the versatility of being able to carry out tests under different conditions. Some of these conditions are that it can generate three types of gas bubble distribution when passing through the porous plates that disperse the injected gas. Depending on the test, the bubbles can be generated with different flow rates of injected gas or air.

The porous plates are preferably made of sintered glass or polytetrafluoroethylene (Teflon), and allow three bubble size distributions to be obtained, these being small, medium and large, ranging from the order of microns to the order of millimeters as required.

In case of having to work with the formation of foams when carrying out a test, such formation of foams can be attenuated by closing the conduits 8 while injecting gas, keeping the upper lid 3 slightly open.

Since in the field gas mixtures (natural gas) are injected which favor the cleaning process due to the interaction between the type of gas (bubbles) with the fluid (water and hydrocarbons with suspended solids of different nature and composition), in the flotation cell of the present invention different gas compositions can be injected through the conduit 9 or just compressed air so as to obtain conditions similar to those in the field. Finally, the flotation cell of the present invention allows working at different pressures and different temperatures. In this way, it is possible to adapt the phenomena studied to conditions as similar as possible to real field conditions and to be able to evaluate the effect of the different parameters in water treatment.

It should be noted that the aim during the tests is to obtain a constant gas flow in order to generate a turbulent regime, but with adequate distribution of bubbles. In other words, the aim is to obtain a turbulent regime where the bubbles carry the oil droplets and suspended solids to the surface.

The cylindrical body 2 of the flotation cell 1 of the present invention further comprises an additional conduit 11 for the placement of measuring instruments, preferably, for the placement of a temperature sensor. Said measuring instruments may be wired to the control unit 6, so that the latter, as described above, can control the temperature and represent it graphically for its display by an operator.

By means of the control unit 6, the band heater 5 can be controlled to heat more or to heat less as required. Said band heater 5 is located below the middle part of the cylindrical body 2 and surrounding the entire outer surface of said cylindrical body 2 so as to achieve a homogeneous heating of the fluid under study. In an embodiment, the band heater 5 allows heating the fluid under study up to 40° C. and can be connected to the control unit 6. In this way, the temperature generated by the band heater through its heating elements can be regulated.

In an embodiment, the flotation cell comprises at least one chamber for monitoring the interior of the cylindrical body and controlling the test dynamically.

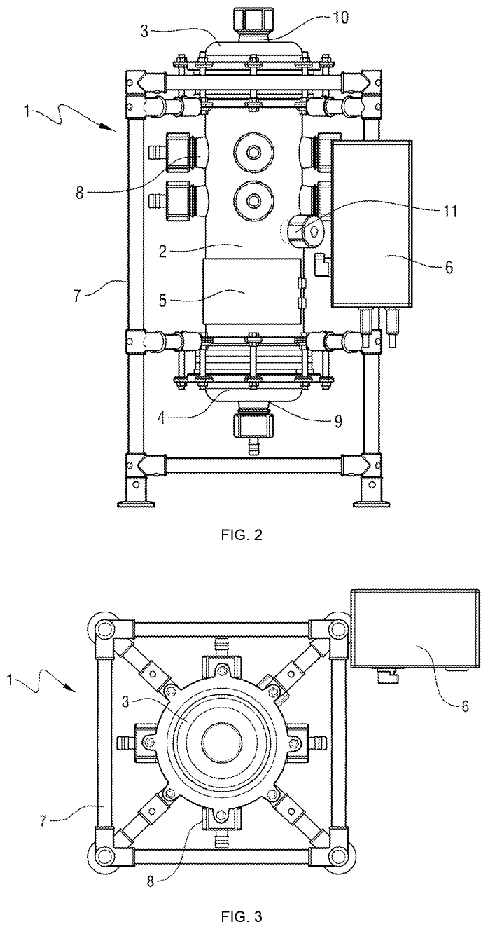

Referring to FIGS. 2 and 3, a right side view and a top view, respectively, of the flotation cell of FIG. 1 can be seen. In particular, in said FIG. 2 the conduit 11 for the placement of measuring instruments can be seen more clearly and in said FIG. 3 the 90° distribution of the conduits 8 of the body 2 can be seen.

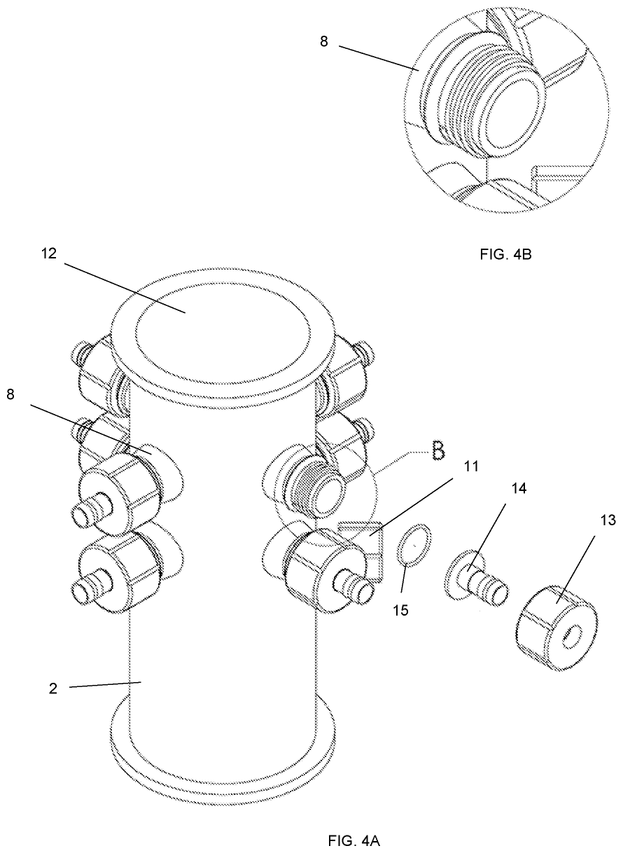

Referring to FIG. 4A, an isometric perspective view of the cylindrical body 2 of the flotation cell with a conduit 8 in exploded view can be seen. In particular, in said FIG. 4A the upper opening 12 of the body 2 and the various components that each of the conduits 8 comprises can be seen. Said components are a nut 13, a spigot 14 and an o-ring seal 15 to ensure tightness, through which the conduits 8 allow the evacuation of supernatant through the connection of hoses to cans.

Replacing the nut 13 and spigot 14 with a blind cap cancels out any conduits deemed necessary. Referring to FIG. 4B, a detail view of the conduit 8 without the components just mentioned can be seen, wherein it can be seen that said conduit 8 comprises an external thread for screwing with the nut 13 or with a blind cap.

In this way, the flotation cell of the present invention allows the possibility of partially closing it since the conduits 8 may comprise blind caps and/or interchangeable spigots according to the design of the test to be carried out whereby the pressure difference and the formation of foam can be controlled.

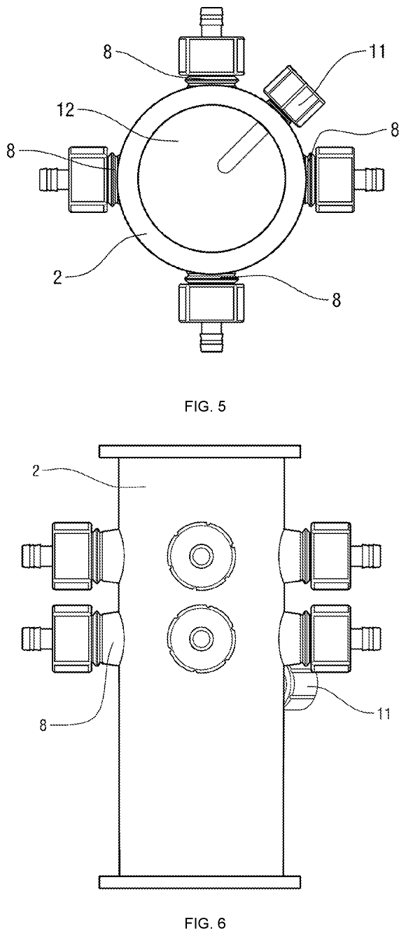

Referring to FIGS. 5 and 6, a top view of the body 2 of the flotation cell of the present invention and a front view of the body of the flotation cell of the present invention can be seen. In particular, in said FIG. 5 it can be seen the inner volume of the body 2 and that said body 2 comprises upper and lower openings. In addition, it can also be seen the conduit 11 for the placement of measuring instruments.

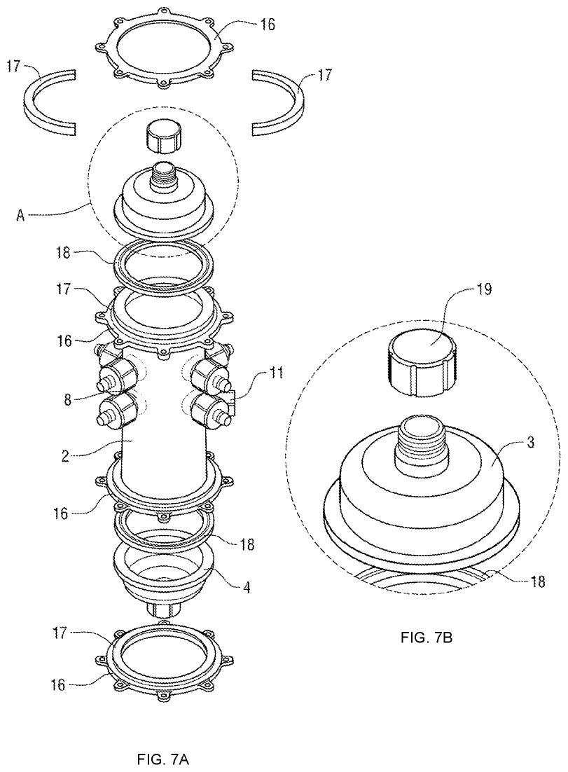

Finally, referring to FIGS. 7A and 7B, these show an exploded perspective view of the flotation cell of the present invention and a detail view of the upper lid of the flotation cell, respectively. In particular, in said FIG. 7A can be appreciated the various components which, by way of example, are used to achieve the tight sealing of the upper lid 3 and lower lid 4 with the cylindrical body 2. Some of said components are flanges 16, inserts 17 and gaskets 18. On the other hand, in said FIG. 7B is shown the conduit 10 with an o-ring seal 15 and a blind cap 19.

The upper lid 3 is attached to the body 2 by means of two flanges 16, which are joined together by studs and nuts (not shown) and which sit on inserts 17 which are preferably made of a thermosetting plastic material. Finally, the tight seal between the upper lid 3 and the cylindrical body 2 is achieved by means of the gasket 18 which is preferably a double o-ring gasket.

As is evident, the lower lid 4 and the body 2 are joined in the same way as the upper lid 3 with said body 2.

1. A flotation cell for water treatment comprising:
a hollow cylindrical body comprising an upper opening, a lower opening and a plurality of conduits distributed on an outer surface of the cylindrical body;
an upper lid and a lower lid attached to the cylindrical body to cover the upper opening and the lower opening, respectively, of the cylindrical body, wherein each lid comprises a conduit;
a band heater located on the outer surface of the cylindrical body, surrounding the cylindrical body;
a support structure comprising a plurality of bars for supporting the cylindrical body and the upper and lower lids; and
a control unit attached to the support structure.

2. The flotation cell of claim 1, wherein the plurality of conduits of the body is located above a middle part of the body.

3. The flotation cell of claim 1, wherein the plurality of conduits of the body comprises four conduits located at a same height of the cylindrical body and spaced 90° apart from each other in relation to a central longitudinal axis of the cylindrical body.

4. The flotation cell of claim 1, wherein the plurality of conduits of the body comprises eight conduits, wherein four conduits of the eight conduits are located at a first height of the cylindrical body, spaced 90° apart from each other in relation to the central longitudinal axis of the cylindrical body; and wherein the remaining four conduits of the eight conduits are located at a second height of the cylindrical body, above the first height, spaced 90° apart from each other in relation to the central longitudinal axis of the cylindrical body.

5. The flotation cell of claim 1, wherein the body comprises an additional conduit for placing measuring instruments.

6. The flotation cell according to claim 5, wherein the additional conduit comprises an elongated body for placing a temperature sensor.

7. The flotation cell of claim 1, wherein a temperature sensor adapter is placed in at least one of the conduits of the cylindrical body.

8. The flotation cell of claim 1, wherein the cylindrical body comprises, in a lower part thereof, interchangeable porous plates that are supported by the lower lid.

9. The flotation cell of claim 1, wherein the band heater is located below the middle part of the cylindrical body.

10. The flotation cell of claim 1, wherein the control unit is a control panel.
